(19) United States
(12) Patent Application Publication
(10) Pub. No.: US 2002/0085784 A1
(43) Pub. Date: Jul. 4, 2002

(54) Integrated lightguide-optoelectronic devices

(76) Inventor: Ernest M. Reimer, Newfoundland (CA)

Correspondence Address: Ian Fincham, McFadden, Fincham, Suite 606, 225 Metcalfe Street, Ottawa, ON, K2P 1P9, CA

(21) Appl. No.: 10/000,344

(22) Filed: Dec. 4, 2001

Related U.S. Application Data
(60) Provisional application No. 60/251,475, filed on Dec. 6, 2000.

(51) Int. Cl. G02B 6/00

(52) U.S. Cl. 385/14

(57) ABSTRACT

The invention comprises a means of integrating optoelectronic devices onto optical lightguides, including optical fibers, the integrated lightguide-optoelectronic (ILO) devices manufactured simply and at a reduced cost by involving lithographic fabrication of optoelectronic devices directly on the termination aperture of a lightguide, eliminating coupling elements such as lenses mirrors, gratings and other devices normally used for one way coupling, for bidirectional coupling and for wavelength division multiplexed coupling. The invention also includes integrated optoelectronic devices comprising an optically active electronic device integrated on an end surface of a lightguide.

### FIELD OF THE INVENTION

The invention is to a method of integrating optoelectronic devices directly onto the termination aperture of a lightguide, and more particularly to the use of organic light emitting diodes and organic photovoltaic technologies and soft lithography techniques that enable bidirectional or multiplex usage of single fibers without the need for conventional multiplexing components and allow for multiplexing of fiber arrays, and to integrated optoelectronic devices formed directly onto the termination aperture of a lightguide.

### BACKGROUND OF THE INVENTION

Fiber optics and other less well known forms of lightguide are used for communications, illumination and sensing purposes. A light guide may be glass or plastic and may be formed as a sheet or fiber. Its purpose is to constrain the propagation path of light rays from some light source, to guide the rays to a destination which may be a light receiver (photodetector), an object to be illuminated or a structure or device that is a sensor for some physical or chemical parameter.

Much of the current art is devoted to the means of coupling light rays from an illumination source into fibers and the means of conveying light out of fibers into a receiver or photodetector. Coupling methods frequently involve a lens that focuses light from a source such as a laser or LED into the termination aperture of the fiber or, that focuses light exiting a fiber onto another fiber or a photodetector. Optical elements such as prisms, holographs and diffraction gratings are also sometimes used. The literature on such techniques is too extensive to review comprehensively, a representative cross section of this repertoire is reviewed below. The objective of this review is to illustrate both the importance and the difficulties inherent in lightguide coupling methods and thereby to underline the novelty of the invention cited herein.

The simplest coupling method currently in practice is “adjacency”. The entrance aperture of the light guide is held in close proximity to the light source. A proportion of the light emitted by the source enters the light guide. The same practice can be used to couple light output from a guide to a photodetector. For small sources (such as LEDs) or small photodetectors, adjacency provides a sufficient coupling. In this case the comparable size of the emitter/detector and the lightguide enables reasonably efficient coupling.

The manufacturing constraint is to provide appropriate mechanical adjacency and alignment. For example, U.S. Pat. No. 6,015,239, 5,448,676, 5,883,684, 5,446,816, 5,195,155, 5,108,167 and 5,812,715 are all of this type. Adjacency is also illustrated in generic terms in Chemical and Biochemical Sensing with Optical Fibers and Waveguides., (G. Boisde and A. Harmer) and also in Fiberoptic Sensor Technology Handbook, (C. Davis et al).

The importance of exact and rapid alignment is illustrated in U.S. Pat. No. 5,993,074 High speed electro-optical signal translator.

Adjacent coupling methods are somewhat inefficient. Lenses are often employed to improve the efficiency of the coupling. The use of a lens generally necessitates more careful alignment practices as seen in the following patents. In all of the cases above there is a need to assemble and align optical components with the fiber termination aperture. This is an exacting operation. Fiber to emitter/detector couplings are relatively expensive because of the exacting nature of the coupling technology.

For large light guides used in illumination, coupling efficiency is a similar concern but alignment is a relatively small part of assembly cost. U.S. Pat. No. 6,086,234 Parabolic and spherical multiport illuminators for lightguides illustrates a lens coupled assembly intended for illumination purposes. This is a large custom assembled device. By comparison with the devices above, no attention is paid to alignment in this patent. Other examples of devices used in microscopic and macroscopic devices are U.S. Pat. No. 4,962,986 uses a high index liquid or solid to effect a “T” coupling; U.S. Pat. No. 5,347,601 teaches use of a MachZender interferometer to effect coupling; U.S. Pat. No. 5,125,054 teaches use of laminar mirror structures in a waveguide interface; and U.S. Pat. No. 5,638,469 teaches use of a hologram to effect efficient coupling.

It is often desirable to provide two way light communications in a single light guide. This is particularly true in the case of optical sensors in which a light is conveyed by fiber to a sensor structure and the modified light must be conveyed back to a detector. [c.f. Chemical and Biochemical Sensing with Optical Fibers and waveguides. (G. Boisde and A. Harmer)]. In sensing as well as communications applications there is a distinct technical and economic advantage in using only a single fiber for the light path to and from the sensor. The means for providing a two-way coupling into the fiber normally involves the use of a beam-splitting by mirrors or other means. For example, U.S. Pat. No. 5,400,419 Illustrates the use of mirrors and U.S. Pat. No. 4,709,413 illustrates the use of partial transmission and adjacency techniques.

Because most emitter and detector technology is fabricated as integrated circuitry on silicon chips by photolithography and etching there is much interest in means for physically inserting optical fibers into the integrated chip structure using channels and other alignment constraints, micro-lenses and so forth so as to achieve good coupling. These assemblies employ integrated optical devices that are intrinsically less cumbersome than the use of discrete optical components. An example of this technology may be found in U.S. Pat. No. 5,392,373 which teaches the use of an etched groove or channel to align a fiber with an integrated structure. Another example being U.S. Pat. No. 5,703,989 and U.S. Pat. No. 5,465,860 which teaches methods for forming waveguides onto integrated circuit chips. These waveguide structures are generally used as a coupling device for the separate optical fibers that convey signal light to and from the integrated circuit. A further example being U.S. Pat. No. 4,895,615 and U.S. Pat. No. 5,387,269 which teach methods for monolithic fabrication of electro-optic couplers and components to enable insertion of optical fibers into integrated circuits. Fiber optic devices are large compared to silicon integrated circuits. The structures for interfacing and holding the fibers are intrinsically wasteful of silicon “real estate” because of this size mismatch.

The desire to increase the communications bandwidth of optical fibers has also led to wavelength division multiplexing methods in which the output from several different light sources emitting at different wavelengths is coupled into a single fiber. This practice requires a more complex array of the same types of coupling technologies reviewed above. U.S. Pat. No. 5,198,008 illustrates a resonant cavity method for wavelength division multiplexing. Wavelength division multiplexing is also desirable in fiber-optic sensors such as chemical probes that operate by colorimetry.

In summary, coupling methods are needed to interface optoelectronic devices to waveguides. Depending on the function, the coupling devices can be complex and challenging to align economically. Recent trends in the art are to fabricate the coupling devices as components on an integrated circuit, providing mechanical alignment channels for insertion of optical fibers.

In the past decade new organic light emitting and photovoltaic technologies have been pioneered by several institutions and companies. The particular attraction of these organic devices is that they can be assembled into functional devices using “soft” lithographic techniques such as ink jet printing. They can also be implemented on flexible polymers (as opposed to rigid silicon). These organic devices are economically attractive for the fabrication of display screens. The art is summarized in Polymer Diodes, R. Friend, J Burroughs & T. Shimoda, in Physics World, June 1999. Also, in a publicly available presentation, Organic Electroluminescent Displays, Richard Friend, published by Cambridge Display Technology. Also U.S. Pat. No. 5,247,190 assigned to Cambridge Research. Also, U.S. Pat. No. 5,688,551 assigned to Eastman Kodak.

The device of the present invention is ideally matched to the “detector” function identified in conjunction with the sensors of this reference as shown in U.S. Pat. No. 6,146,593. Thus, the ILO device of the present invention would significantly enhance the economics of the bio-sensor described in this reference.

### SUMMARY OF INVENTION

The invention comprises a means of integrating optoelectronic devices to optical light guides including optical fibers. The advantages of the integrated lightguide-optoelectronic (ILO) devices are simplicity and reduced manufacturing cost. The means involves lithographic fabrication of optoelectronic devices directly on the termination aperture of the lightguide. The advantage is the elimination of coupling elements such as lenses, mirrors, gratings and other devices that are normally used for one way coupling, for bi-directional coupling and for wavelength division multiplexed coupling.

Terms Used:

Lightguide refers to a class of devices for guiding light from a source to a destination point through a constrained path, usually a refractive waveguide in which the light path is constrained by total internal refraction. The form of light guide may be an “optical fiber”, as sheets and embossed planar devices. “Lightguide” may also refer to a bundle of optical fibers that are used to convey light from a source to a destination point for the purposes of illumination.

Another reference to “Lightguide” may be to light guiding channels that are not fibers.

Optical fiber refers to single fibers that are used to convey light for communications and sensing purposes.

Optoelectronic devices may include photodetectors, light emitting diodes, lasers or other light sources that are used to illuminate the input aperture of a light guide and/or a transmitter.

Light receiver or photodetector refers to a transducer that receives light from the output aperture of a lightguide and converts it into an electrical signal or amplifies it.

Aperture means the lightguide's designed entry and/or exit point for light. In the following text the “termination aperture” of an optical fiber is depicted as orthogonal to the propagation axis of the fiber. This is not a necessary condition, the termination may be oblique. Side aperture terminations are also possible etc. The termination aperture may be either an entrance aperture or an exit aperture or both.

### BRIEF DESCRIPTION OF THE DRAWINGS

Having thus generally described the invention, reference will now be made to the accompany drawings and describing preferred embodiments and in which:

FIG. 1 is a cross-sectional view of the present invention;

FIG. 2 is a side elevational view of a device according to the present invention;

FIG. 3 is a side elevational view of a device as in FIG. 2 with further added components according to the present invention;

FIG. 4 is a side elevational view of a device as in FIG. 2 in an embodiment of the invention;

FIG. 5 is a side elevational view of a device in the further embodiment of the invention as in FIG. 4 with further added components;

FIG. 6 is a side elevational view of a device in another embodiment of the invention;

FIG. 7 is an end elevational view of a device in another embodiment of the invention as in FIG. 4 with further added components;

FIG. 8 is an end elevational view of a device in a still further embodiment of the present invention as in FIG. 2;

FIG. 9 is an end elevational view of a device in a still further embodiment of the invention as in FIG. 8;

FIG. 10 is an end elevational view of a device which is a modification of the embodiment of the present invention as in FIG. 4 in use with a Kinotex sensor;

FIG. 11 is an end elevational view of a device according to a further embodiment of the present invention as in FIG. 5 in use with an optrode;

FIG. 12 is an end elevational view of a device according to still another further embodiment of the invention.

In the following description, the following reference numerals designate the following parts/components.

1. Optical fiber, diameter 250 pm;

1a. a termination aperture of optical fiber;

2. interfacial layer (optional, non-conductive, transparent polymer, thickness <1 μm);

3. transparent electrode layer (indium tin oxide, thickness 20 pm)

4. light emitting organic (poly(p-phenylenevinylene, thickness, as an example, at 100 nm to 1 μm));

5. electrode layer (aluminum or calcium with a typical thickness 20 nm);

6. isolation layer (non-conductive polymer, thickness >1 μm));

7. emitted light ray propagating axially through fiber;

8. polymer LED matrix, total thickness 1 μm to 10 μm, area of “pad” being arbitrary;

9. Epoxy embedment block;

10. Electrical contact pads;

11. LED pads (4), multiple wavelength emitters;

11a. Photovoltaic detector pad; and

12. Optical barrier to minimize emitter-detector cross talk.

In the above description, various thicknesses and diameters of components have been described. These are only representative examples of sizes, component types, and are not intended to be limiting in scope. It will be understood that various embodiments can be employed.

### DETAILED DESCRIPTION OF THE DRAWINGS

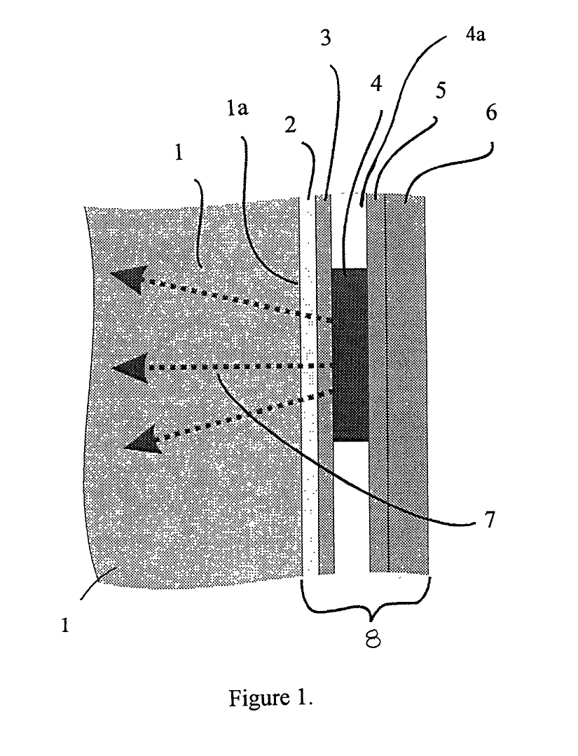

Referring now to FIG. 1, there is illustrated an optical fiber 1 with termination aperture (1a). The termination aperture for a plastic fiber may w have a diameter in the range of 0.1 millimeter to 1 millimeter. The ensuing description assumes the use of a 0.25 mm plastic (polymethylmethacrylate) fiber but the art can be applied equally to fibers of other dimensions and other materials including glass fibers. The termination aperture of the fiber may be covered with a thin (10 nanometers to 100 nanometers) interfacial layer 2. This layer may provide chemical barrier and can provide adhesion for the successive layers. The interfacial layer is then “printed” with a transparent conductive layer 3 in a pattern that defines an electrode and a connection path. This layer may be indium tin oxide about 20 nm thick. The electrode area of layer 3 is covered with a light emitting organic (or photovoltaic organic) layer 4. This material may be poly(p-phenylenevinylene) in a thickness of 1000 nm. Other areas on the fiber face are covered with an insulating polymer layer 4(a). The next layer 5 is a light reflecting conductive layer of aluminum or calcium laid out in a pattern to complete a conductive path and anode for the light emitting layer. The entire assembly may be topped with a polymer layer 6 for chemical and mechanical protection of the underlying structure. The entire assembly comprises a film one or two microns thick and may have lateral dimensions of several hundred microns. The lateral dimensions of the device are determined by such considerations as output power, device packing and printing resolution. An LED or photodetector element will have lateral dimensions that are likely greater than 5 microns×5 microns but normally smaller than the diameter of the fiber. The actual form of the optoelectronic device can vary.

As described above, the various layers are conveniently formed or deposited by a lithographic process, including ink jet printing.

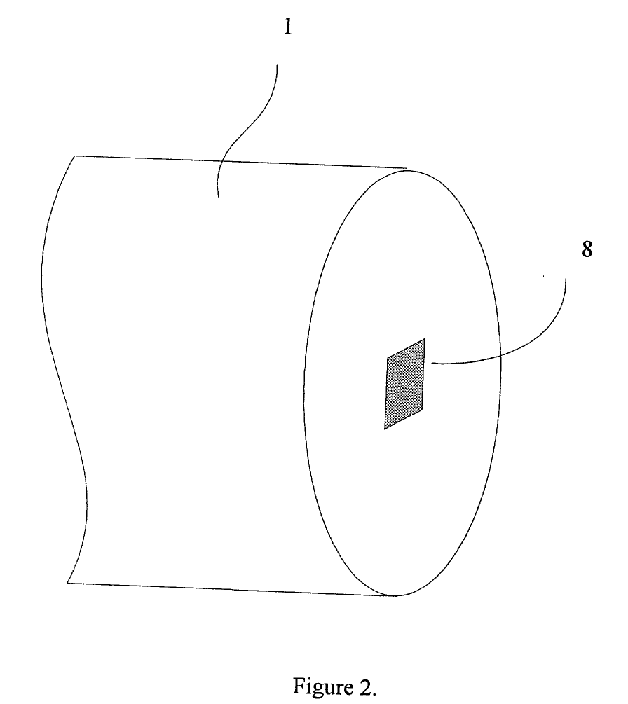

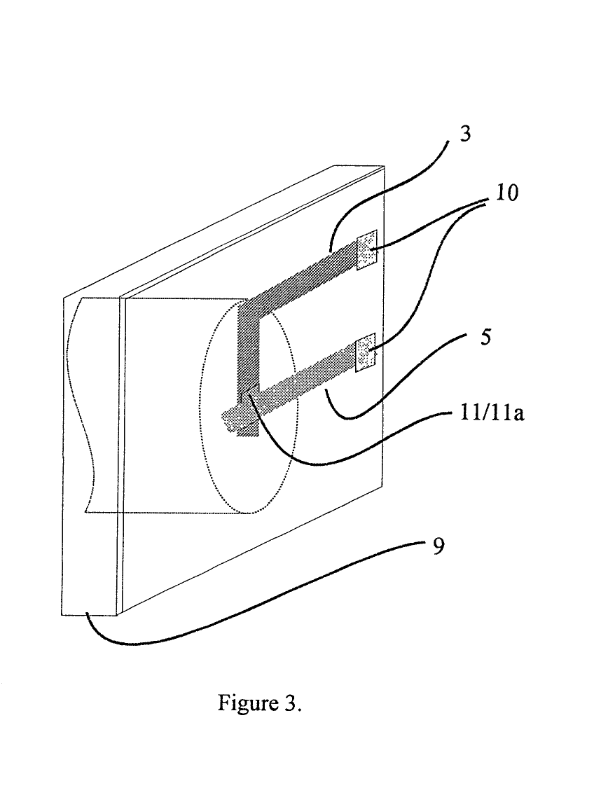

Turning now to FIGS. 2 and 3, FIG. 2 illustrates an LED element 8 on the face of an optical fiber 1. The thickness of these devices is negligible compared to the diameter of the fiber. The optoelectronic device is integrated into the fiber itself. FIG. 3 illustrates a more complete assembly as it might appear in practice. A polymer block 9 (e.g. an ultraviolet curing epoxy) is formed around an optical fiber. The forward face of the block is flush with the end face of the fiber. This block provides a mechanical interface for fixing and handling of the fiber. It provides a wider surface for interfacing the optoelectronic devices to electrical conductors. The block provides an extended planar surface for printing of conductors 3,5 that connect to the emitter/detector devices that are printed on the face of the fiber. Pads 10 for wire bonding or other electrical connection are provided at the periphery of the block.

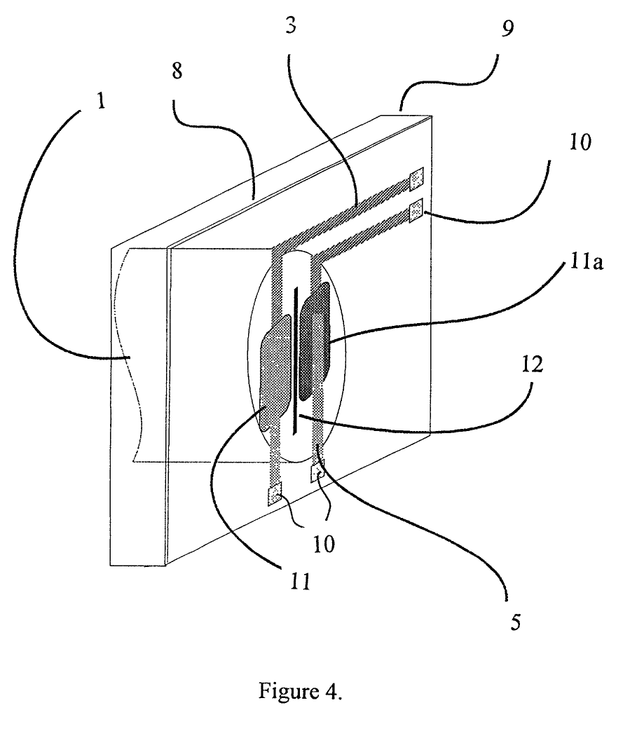

FIG. 4 shows two optoelectronic devices integrated to the optical fiber. One is an LED 11 and the other is a photodetector 11a. There is an optical barrier 12 between them to prevent direct illumination of the detector 11a by the LED 11. This integrated assembly enables bidirectional transmission in a single fiber without the need for a beam splitter or other devices.

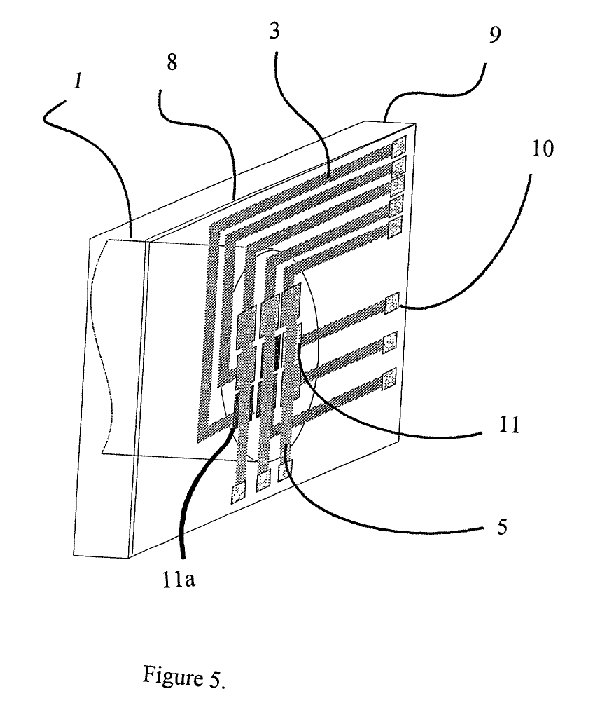

FIG. 5 illustrates an array of multiple wavelength emitters 11 (and/or detectors 11a) integrated to the face of the fiber. Each emitter/detector operates at a different waveband. This arrangement enables the simultaneous transmission of many different wavelength signals in the single fiber. The multiple detector elements will have an intervening wavelength filter layer so as to be specific for a particular waveband.

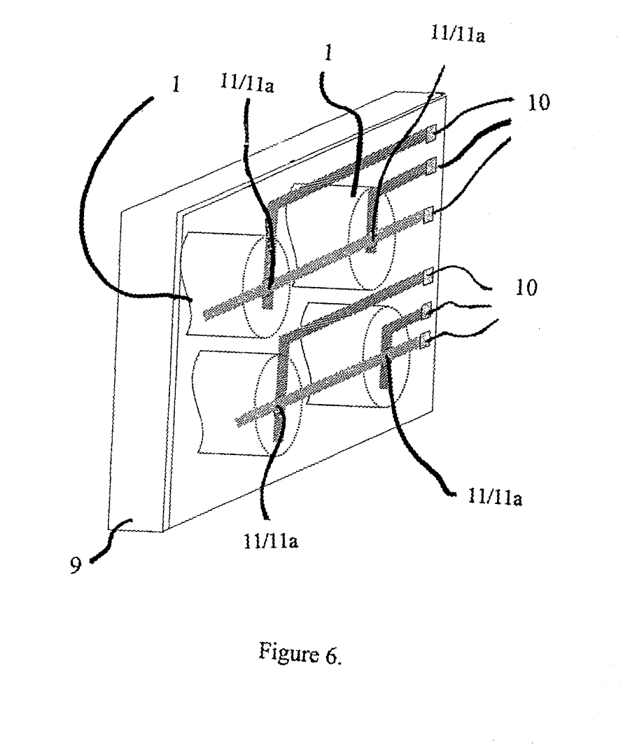

FIG. 6 illustrates a two dimensional fiber array in which each fiber has an integrated emitter 11 or detector 11a. Such an array may be linear or two dimensional. Large numbers of fibers can be discretely illuminated in this way. All of the fibers in the array could, for example, be successively illuminated for a brief period. This sequentially multiplexed illumination would enable the assembly of low cost sensing arrays consisting of many illuminated fibers and a single photodetector.

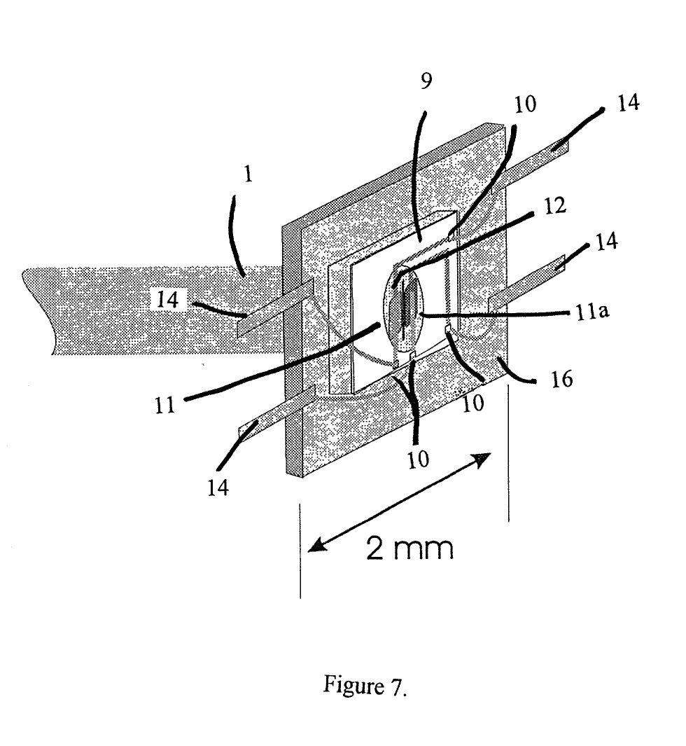

FIG. 7 illustrates a more complete view of the FIG. 4 bi-directional ILO device suitable for two way sensing or communication. The device includes electrical prongs or solder tabs 14 for circuit interconnection.

The integrated transmitter and receiver could be replicated at each end of the fiber to provide a complete two-way communications channel with electrical input and output.

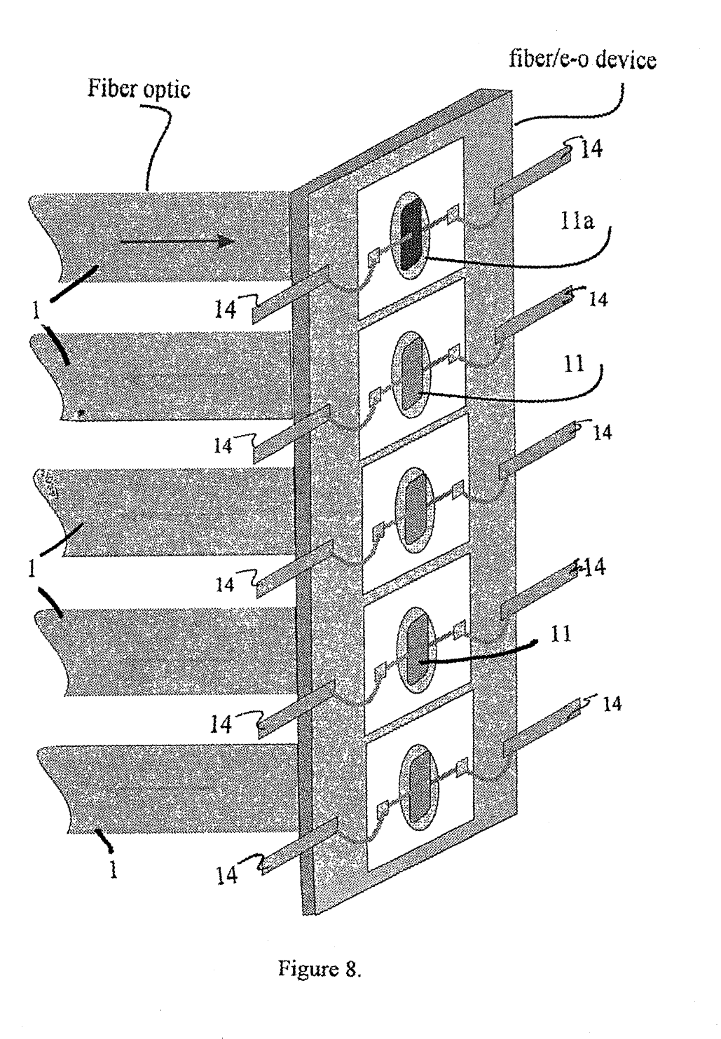

FIG. 8 illustrates a multi-fiber assembly in which many fibers are discretely illuminated but only one fiber is used as a receiver channel having a receiver, or detector, 11a. The remaining fibers have emitters 11. This ILO device could be used in a sensor array such as Kinotex in which many taxels are illuminated sequentially by the emitter fibers and all taxels are read by the single receiver.

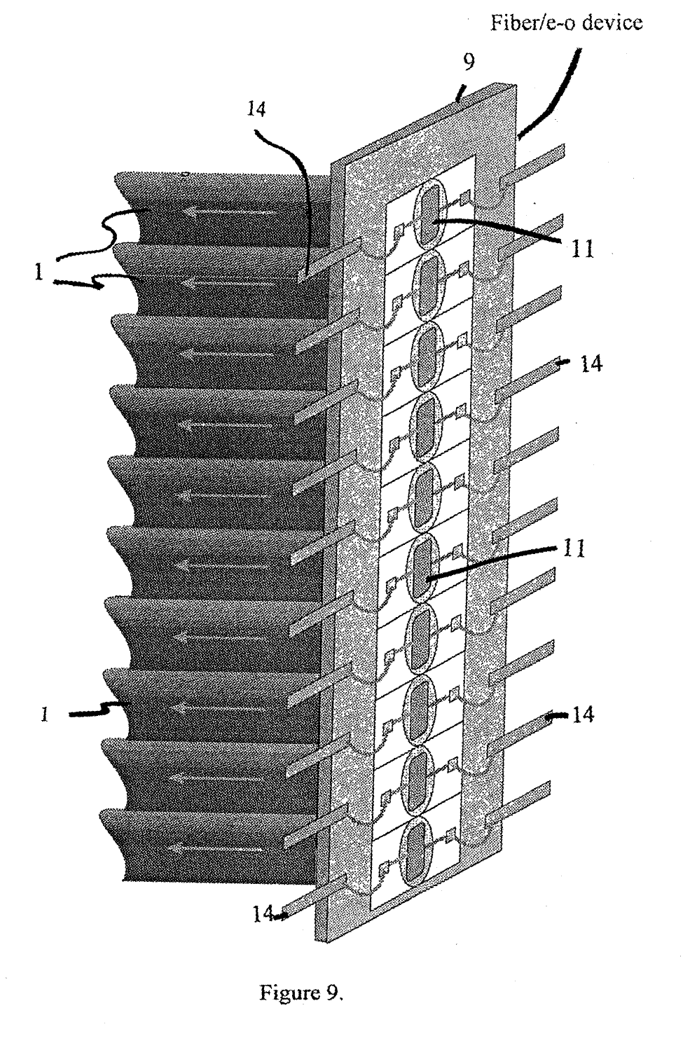

FIG. 9 illustrates a fiber ribbon array with discrete illuminators or emitters 11 fabricated on the fiber apertures in a single line array. This is a more specific configuration of FIG. 8. In a Kinotex sensor this device might be used in conjunction with a separate photodetector technology.

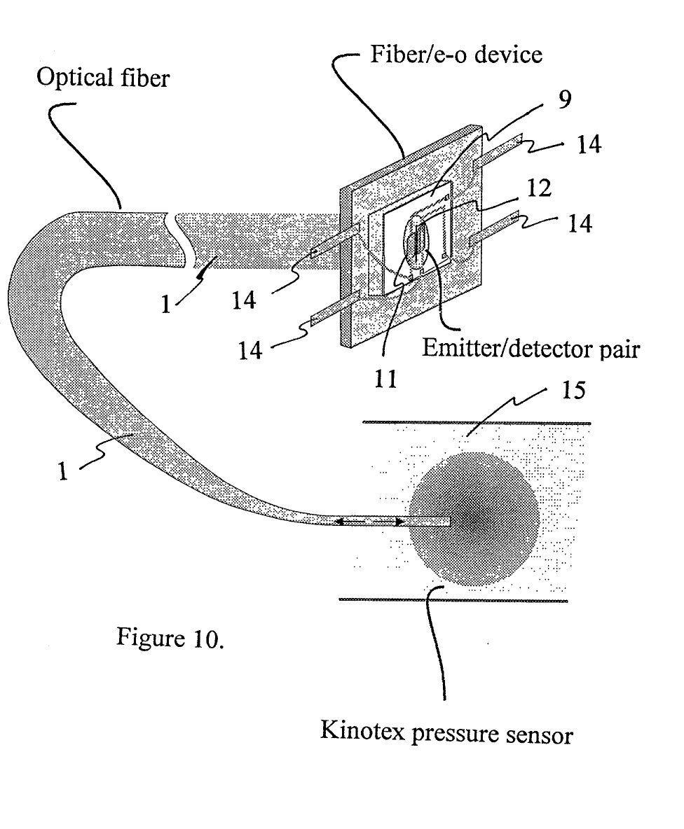

FIG. 10 illustrates a Kinotex pressure sensor fabricated using a bidirectional ILO device having an emitter 11 and a detector 11a. The ILO emits light into a deformable integrating cavity 15 and receives light from the cavity, the receiver signal indicates the extent of deformation of the cavity 15. The cavity can be at any convenient position with remote sensing.

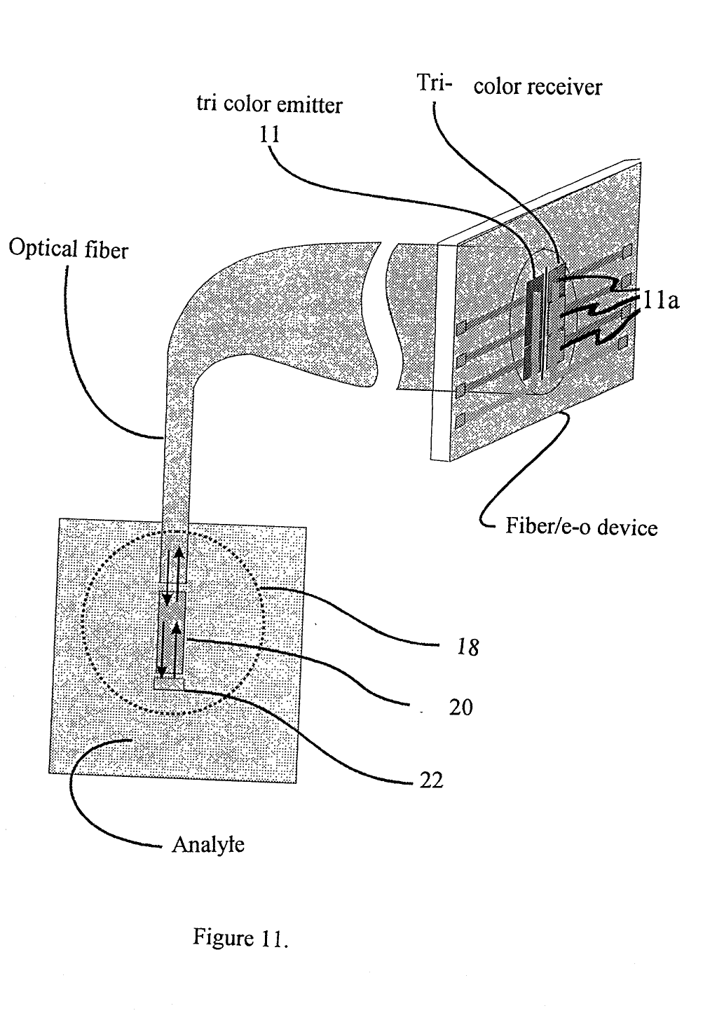

FIG. 11 illustrates a wavelength division multiplexed chemical sensor. The emitter 11 of the ILO emits three separate optical bands into the “optrode 18”. The returned signals, via mirror 22, is received at three wavelength sensitive receivers. The received signal strength can be analysed to determine the extent of reaction of the indicator reagent 20 in the optrode. The art is well known in the industry. The optrode is positioned in an analyte 24.

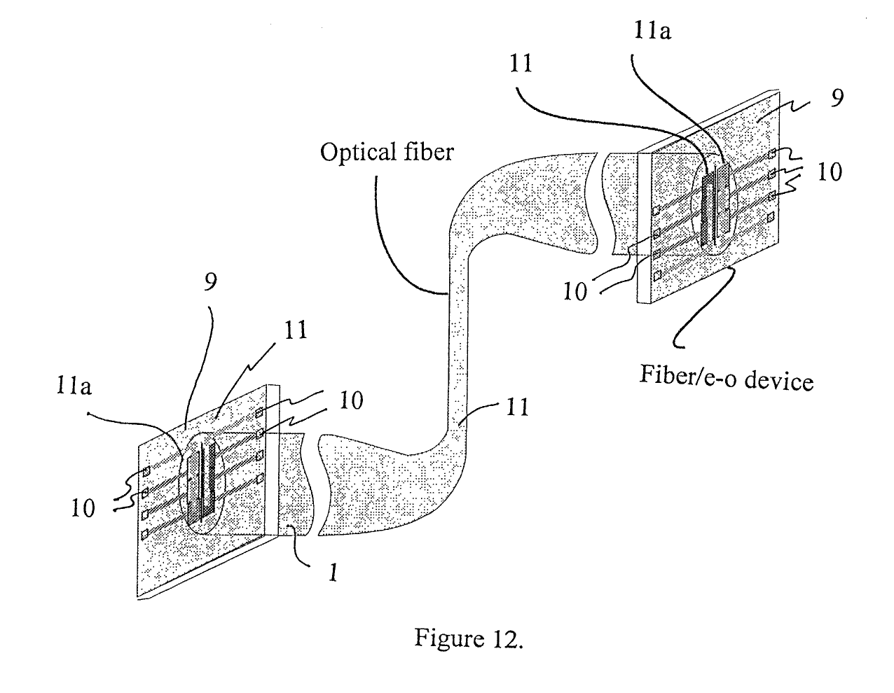

FIG. 12 illustrates a wavelength division multiplexed ILO device for high bandwidth communications, using tri-color emitters 11 and tri-color detectors 11a.

With the invention of the present application it will be understood the elimination of optical and mechanical coupling devices represents a significant achievement in various arts. Thus, for example, the ILO transmitter can be used as an illuminator or ILO receiver for use as a photodetector; a single fiber ILO with transmitter and receiver for use as bidirectional communications channel; a single fiber ILO with transmitter and receiver for use in conjunction with an optical sensor, a single fiber ILO with transmitter and receiver for use in conjunction with a Kinotex sensor, an ILO configured as a wavelength division multiplexed device for broadband communications, an ILO configured as a wavelength division multiplexed device for use with an optical sensor or “optrode” or a Kinotex pressure sensor array utilizing an ILO array for illumination of the discrete taxels. Kinotex pressure sensor array utilizing an ILO array for illumination and readout of the discrete taxels.

The particular form of the optoelectronic device, or devices, can vary, for example in positioning and structure of the various layers and other details.

Although the present invention has been described by way of preferred version, it will be seen that numerous departures and variations may be made to the invention without departing from the spirit and scope of the invention as defined in the claims.

We claim:

1. A combination of lightguide and optoelectronic device comprising a lightguide having a first end surface and a termination aperture at said first end surface and at least one optically active electronic device integrated on said end surface at said termination aperture.

2. A combination as claimed in claim 1, said optically active electronic device comprising a light emitter.

3. A combination as claimed in claim 1, said optically active electronic device comprising a light detector.

4. A combination as claimed in claim 1 said optically active electronic device including a transparent conductor layer, a light emitting layer on said conductor layer and a light reflecting conductor layer on said light emitting layer.

5. A combination as claimed in claim 4, said layer produced lithographically.

6. A combination as claimed in claim 5, at least one of said layers ink jet printed.

7. A combination as claimed in claim 1, said lightguide mounted in a polymer block having a forward surface, said end surface of said lightguide flush with said forward surface.

8. A combination as claimed in claim 7, including contact pads on said block, and conductor patterns on said forward surface connecting with said optically active electronic device.

9. A combination as claimed in claim 1, including two of said optically active devices on said end surface.

10. A combination as claimed in claim 9, one of said optically active devices an emitter.

11. A combination as claimed in claim 1, including a plurality of optically active devices in an array.

12. A combination as claimed in claim 11, at least one of said devices an emitter.

13. A combination as claimed in claim 11, including a plurality of said lightguides mounted in a polymer block having a forward surface, end surfaces of said lightguide flush with said forward surface, each lightguide having at least one partially active electronic device on an end surface.

14. A combination as claimed in claim 12, said lightguides having a further end surface, remote from said first end surface, a further termination aperture at said further end surface, and at least one optically active electronic device integrated on said further end surface at said further termination aperture, to form a transmission device.

15. A combination as claimed in claim 1, said lightguide having a further end, said further end positioned in a pressure capsule, light emitted from said further end into said capsule and recovered back into said further end, said recovered light modulated in accordance with pressure variation.

16. A combination as claimed in claim 1, said lightguide having a further end, and a mirror on said further end to return light, said further end positioned in an optrode in a chemical solution, the returned light modulated in accordance with said chemical solution.

17. A method for making a combination of lightguide and optrode device, comprising; forming at least one optically active electronic device at a termination aperture on an end surface of said lightguides.

18. A method as claimed in claim 17, said electronic device including a transparent conductor layer, a light emitting layer on said conductor layer, and a light reflecting conductor layer on said light emitting layer, including forming said layers lithographically.

19. A method as claimed in claim 18, including producing at least one of said layers by ink jet printing.

20. A method as claimed in claim 17, including mounting said lightguide in a polymer block having a forward surface, an end face of the lightguide flush with said forward surface.

21. A method as claimed in claim 17, including mounting a plurality of lightguides in a polymer block, having a forward surface, end surfaces of said lightguides flush with said forward surface.
